(19) United States
(12) Patent Application Publication
(10) Pub. No.: US 2016/0229009 A1
(43) Pub. Date: Aug. 11, 2016

(54) GEAR WHEEL PRODUCTION METHOD

(71) Applicant: SIEMENS AKTIENGESELLSCHAFT, München (DE)

(72) Inventors: ARNO KLEIN-HITPASS, Aachen (DE); JEAN-ANDRE MEIS, Duelmen (DE); JAN-DIRK REIMERS, Aachen (DE)

(73) Assignee: SIEMENS AKTIENGESELLSCHAFT, 80333 München (DE)

(21) Appl. No.: 15/024,897

(22) PCT Filed: Sep. 25, 2014
(86) PCT No.: PCT/EP2014/070453

§ 371 Date: Mar. 25, 2016

(30) Foreign Application Priority Data
Sep. 26, 2013 (DE) 10 2013 219 445.5

(51) Int. Cl. B23P 15/14; G01N 3/56; F16H 55/17; B23K 26/211

(52) U.S. Cl. CPC B23P 15/14; B23K 26/211; G01N 3/56; F16H 55/17

(57) ABSTRACT

In a method for producing a spur-cut gear wheel, a plurality of individual components are provided with at least one hub, a disk wheel and a ring gear. The individual components are subjected to at least partial mechanical soft machining and joined by using a welding method. At least the ring gear is hardened and hard machined. Before carrying out a grinding burn test by using the nital etching process, gaps present on the rear side in the area of the welds produced during welding are sealed by using a sealing material that is resistant to nitric acid.

The present invention relates to a method for producing a spur-cut gear wheel comprising a plurality of individual components.

A fundamental aim of gear construction is to achieve a torque transmission which is as high as possible at the desired rotational speed. In this case, firstly the safety requirements of the individual gear components have to be achieved, dictated by the application. Secondly, the construction has to be able to be produced cost-effectively. The key components are in this case, amongst others, the toothed components such as the crown wheels, planetary gears, sun gears, pinion shafts and spur gears, wherein due to their diameter and weight said components are worn out to a very significant degree in terms of their gear teeth. To this end, it is always necessary to produce the spur gears from a high quality gear tooth steel having a low likelihood of defects and a high degree of purity. Moreover, they have to be manufactured with the greatest degree of accuracy.

To achieve the required flank and root strength in most cases it is necessary to harden at least the toothed region of a gear wheel. A maximum flank and root strength of the teeth is achieved by so-called case hardening which comprises the machining steps of carburization, hardening and tempering. According to the current prior art, only with such case hardening is the highest specific power density and safety able to be achieved as may be demanded, in particular, in potentially slow-running large transmission gear wheels subjected to high loads.

It is known to produce smaller gear wheels and large transmission gear wheels, i.e. gear wheels with external diameters of 600 mm or more, from a single blank. The technical production sequence of such gear wheels is subdivided into three main machining phases and subsequent quality control. The machining phases are the soft machining, the hardening and the hard machining. These phases are in turn subdivided into the respective sub-machining steps.

During the soft machining, in the case of rod material in a first step the unmachined component is initially cut to length. Subsequently the unmachined component is pre-turned and drilled so that an annular configuration is obtained.

In the case of pre-forged perforated disks, which are economically expedient in particular in the case of larger diameters, the pre-turning and drilling also takes place initially. Here it is a case of the material saving being already acceptable in terms of cost-effectiveness by the premanufactured central bore.

In both possible embodiments of unmachined parts the gear teeth are produced subsequently, for example by milling of the gear teeth or the like. Finally, a deburring of the gear teeth then takes place.

During the hardening, in the case of case hardening the regions of the component without gear teeth are covered in a first step. Subsequently, the carburization of the component takes place in which the component edge layer is enriched with carbon. Subsequently the component is hardened, for example by quenching of the component in a liquid or gaseous quenching medium, whereby a component is achieved with a high surface hardness and hardness. In a further step the tempering of the component takes place, wherein the hardness is again slightly reduced but also disadvantageous residual stresses are substantially reduced. The component core, however, remains in a toughened and tempered state. During the case hardening, care has to be taken that all component surfaces, which have to be covered during the hardening of the component, are designed to be accessible. All surfaces which are to be further processed later are covered, such as for example shaft seats, grooves, short gear teeth, bores or threads, if they have not already been implemented. The loading into the hardening furnace is carried out by taking account of the thermal transitions and the deformation due to the dead weight of the components. Pre-existing conditions also have to be taken into account for the quenching process. The quenching means should be able to flow unhindered around the component, which is why undercuts and cavities have to be avoided. Potentially undercuts and primarily cavities may be provided with throughflow bores which, however, lead to non-uniform quenching even when the introduction of air is avoided thereby.

In a subsequent step, the component is normally cleaned by means of cleaning jets. The cleaning jets are designed to be able to reach directly the relevant surfaces. Cavities are accordingly not able to be cleaned. The granulate should be able to be removed from the component cavities.

During the subsequent hard machining, a mechanical machining of the component takes place in the hardened state. Thus, the component may be hard-turned in a first step and subsequently grooved. Then a grinding of the gear teeth takes place.

For carrying out turning, milling and grinding during the course of the soft machining and hard machining, the component has to be received in the corresponding machine. To this end, clamping plates, clamping mandrels or expanding mandrels are used. Moreover, there is the possibility of using zero clamping plates. During internal machining, tension is applied over the outer surfaces, wherein general aligning surfaces are applied to the tip circle surface before being clamped on both sides. The side surfaces have a preferred side for clamping. In principle, the specifications of the clamping surfaces and clamping means, the tool outlets and tool radii have to be taken into account. For the tolerancing, care has to be taken whether the machining has to take place within one chuck or within several chucks.

After carrying out the hard machining the component thus produced is tested, measured and deburred.

During the course of the quality control, depending on the parameters to be tested, different methods are used. Thus a gear wheel, for example, may be subjected to a crack test, a surface hardness test, a grinding burn test or the like.

The grinding burn test serves to monitor the hard machined component for damage, which has been produced by the grinding of the hardened gear teeth. During the grinding, in the case of an unfavorable process sequence this may result in localized overheating of the grinding regions, whereby newly hardened zones or tempering processes are implemented which may lead to subsequent malfunction of the gear wheel. One of the most common grinding burn tests is carried out by the use of the nital etching method. During such a nital etching process the gear wheel is completely immersed in a nitric acid bath, which leads to surface peeling and/or etching of the joint structure. This acid acts at different levels depending on the grain orientation and the microstructure of the joint, whereby during a suitable process sequence, shading of the joint visible to the eye is revealed, which becomes apparent during further hardening or reduction of the case hardening compared to the correctly hardened structure. After nital etching the acid has to be removed again from the component in order to counteract damaging effects, such as for example damage to the component by hydrogen-induced stress crack corrosion, contamination of the transmission oil by corrosive products or by non-readily soluble salts or even by acid spreading into the cleaning baths due to inadequate drainage, etc. in order to name just a few examples.

A drawback of the one-piece configuration of gear wheels is, with an increasing external diameter of the gear wheels, that said gear wheels are extremely disadvantageous regarding the requirement for material and production weight. As a solution to the weight problem it is known to incorporate beads in the design of large gear wheels. In other words, material is removed from the wheel side surfaces during the course of the turning operation. As a result, however, the production costs are negatively impacted as further cutting operations are required for the incorporation of beads and this material has already generated costs in the purchase of unmachined parts.

A further problem occurs with the increasing external diameter of the gear wheel during the case hardening. During this process, a large amount of energy is introduced into the component, which during the quenching process may lead to significant component deformation. This component deformation has to be compensated both in advance by costly structural measures and retrospectively by a corresponding removal of material. For improving the capacity for hardening and/or the quenching process, for example, it is known to introduce bore holes into the component which are intended to ensure that the component is rinsed more uniformly by the quenching medium in order to achieve an improved temperature curve of the component during cooling and thus reduced deformation. For subsequent removal of material, the component has to be designed with corresponding measurements so that the subsequent removal of material may take place to the desired dimensions. The subsequent removal of material nevertheless has to take place in the hardened state of the component which is associated with considerable costs and is correspondingly uneconomical.

In spite of these expensive and complex countermeasures, however, in practice it is only possible with difficulty to restrict the component deformation to limited regions and in a controlled manner. As a result, in particular large gear wheels configured in one piece, which are produced in the manner described above, are a cost-effective compromise between material costs and production costs but as a whole only cost-effective to a limited degree.

As an alternative to gear wheels configured in one piece of the type described above, hybrid gear wheels which are made up of a plurality of components are known and namely of at least one hub, a wheel body arranged on the hub and a ring gear arranged on the external periphery of the wheel body. Such hybrid gear wheels have to be comparable in their power conversion with the same degree of safety. They have to be able to be produced cost-effectively and have a similarly high production quota as permitted by the current gear wheels which are configured in one piece and case hardened.

Very different embodiments of such hybrid gear wheels which essentially differ in the manner in which the individual components are fastened together and in the design of the individual components are already known in the prior art.

The fastening of the individual components to one another may be carried out mechanically, thus the ring gear for example may be screwed to the wheel body. Alternatively, it is also known to shrink the ring gear onto the wheel body, wherein the ring gear is frequently secured against a relative movement with regard to the wheel body by corresponding positive locking devices.

Alternatively, the individual components may also be connected together by a material connection, by means of welding. In addition to the reliability of their gear teeth, welded gear wheels have to be additionally designed relative to their interface properties. The joint interfaces are made up of the combinations of components including the ring gear and wheel body (so-called gear rim), the wheel body and hub as well as the hub and shaft. These joints have to be taken into account in the design calculations and production planning. Moreover, the cost thereof in terms of production technology and the effect on component function has to be taken into account.

A known production sequence for hybrid large transmission gear wheels consists, for example, in the provision of unmachined parts, pre-turning, welding, gear teeth cutting, optionally induction hardening, gear teeth grinding and subsequent quality control.

The welding processes in large transmission gear wheels have been exclusively implemented hitherto by means of MSG welding (metal shielding gas welding), electrode welding or submerged arc welding—all methods using consumable electrodes and, by comparison, high energy per unit length—and therefore have a significant effect on the metallurgical properties of the connection and the basic material. The welding process as such causes, however, high residual stresses in the steel structure. With this in mind, it is usual nowadays for the person skilled in the art to carry out stress relief tempering after the welding process in order to dissipate stresses in order to prevent further production steps from potentially releasing these stresses as deformation, such as for example when incorporating beads, when asymmetrically reducing the wall thickness, or the like. These deformations which accompany the production process are known and lead to weaknesses in the welded structure. Accordingly, highly accurate dimensional machining of a welded large transmission gear wheel is only possible after carrying out stress relief tempering.

The hardening of the welded component takes place at least in large transmission gear wheels by means of induction hardening. This method has the advantage that only a relatively small amount of thermal energy is introduced locally into the component, whereby high level of component deformation is prevented.

Case hardening of the welded component, as is used in the large transmission gear wheels configured in one piece, is not used in hybrid large transmission gear wheels due to the high residual stresses introduced by the welding process using consumable electrodes. In large transmission gear wheels small deviations in terms of dimensions already lead to greater shape deviations. The deformation due to the dissipation of the residual stress as a result of welding and the deformation due to hardening become cumulatively so great that a costly mechanical machining might be necessary in the hardened state of the component. However, this is undesirable as it results in significant costs. Accordingly, in known large transmission gear wheels the ring gear is always manufactured from tempered steel.

With small gear wheels, however, deviations caused by component deformation lead to fewer shape deviations than in large transmission gear wheels, as a result of the dimensions, which is why the aforementioned problems of deformation for hybrid large transmission gear wheels introduced into the component by the welding and hardening processes in this case only plays a minor role, in particular if only a lower grade gear teeth quality is required, as they are used in the context of fatigue strength. This is the case in mobile transmission applications, such as for example in motor vehicles and utility vehicles.

For producing hybrid small gear wheels, for example, a method is known in which initially the unmachined parts are provided, whereupon pre-turning of the corresponding components takes place. Subsequently, case hardening follows whereupon grinding of the teeth optionally takes place. In a further step, the individual components are connected together by means of electron beam welding in the hardened state. The electron beam welding in this method, therefore, is used for case hardened small gear teeth, more specifically on already hardened and if required ground gear teeth. The electron beam welding which is also suitable for mass production, by comparison has very low deformation and permits this production sequence with small gear wheels.

A drawback with currently available hybrid gear wheels relative to gear wheels configured in one piece is that a grinding burn test is not able to be carried out easily by means of nital etching. After immersing in the etching bath, the acid, as has already been described above, has to be removed from the component in order to counter a further attack on the metal. Such a removal of acid is not a problem in the case of gear wheels configured in one piece. In hybrid gear wheels, however, correct removal of acid may be difficult or even prevented by gaps remaining between the individual gear wheel components after welding, which is why the described drawbacks, which are associated with the acid remaining on the component, are hardly encountered or not even encountered at all.

A further drawback with currently available hybrid large transmission gear wheels, i.e. gear wheels with an external diameter of 600 mm or more, relative to large transmission gear wheels configured in one piece, is that they are only able to be used for small surface loads as the tempered ring gears have a lower load-bearing capacity than case-hardened ring gears. While the flank strength in hybrid large transmission gear wheels ranges from approximately 600-800 N/mm², case-hardened large transmission gear wheels configured in one piece have, a flank strength of approximately 1,500 N/mm², with carbonitriding up to 1,700 N/mm². A further drawback is that the nature of the welding methods using consumable electrodes, used hitherto in the production of hybrid large transmission gear wheels, is highly manual and at the same time extremely time-consuming which is why they are only able to be used cost-effectively in batch production. A detection of process data during mass production does not currently form part of the prior art and is only able to be documented by means of retrospective quality controls.

Further prior art is disclosed in the publications DE 911500 B, DE 917 589 B, DE 26 06 245 A1, DE 34 27 837 C2, DE 10 2007 040 894 B4 and DE 10 2006 025 524 A1.

Proceeding from this prior art, it is an object of the present invention to provide a cost-effective method for producing, in particular for mass producing, a spur-cut gear wheel by which a gear wheel may be produced with a low dead weight, which may be designed for the highest loads, even when it is a large transmission gear wheel, and which during nital etching may be easily monitored for grinding burn, without damage to the gear wheel being feared as a result of the grinding burn test.

To achieve at least partial aspects of this object, the present invention provides a method for producing a spur-cut gear wheel consisting of a plurality of individual components which comprises the steps:
a) providing the individual components which comprise at least one hub, a disk wheel and a ring gear,
b) at least partial mechanical soft machining of the individual components, c) joining the individual components by using a welding method,
d) hardening at least the ring gear,
e) hard machining at least the ring gear and
f) carrying out a grinding burn test by using the nital etching process,
   wherein before carrying out step f) gaps present on the rear face in the region of the weld seams produced in step c) are sealed by using a sealing material which is resistant to nitric acid.

An essential advantage which is associated with the fact that the gear wheel according to the method according to the invention is produced from a plurality of individual components is that relative to a gear wheel produced in one piece the dead weight of the gear wheel may be reduced without excessive material losses. A further advantage is seen to be that due to the sealing of the gaps present on the rear face in the region of the welded seams which remain when the individual components are connected by being welded on one side, by using a sealing material which is resistant to nitric acid during grinding burn testing, no nitric acid is able to penetrate the gaps. Accordingly, after carrying out the grinding burn test the nitric acid may be easily rinsed away and/or neutralized without undesired damage to the gear wheel being feared by the residue of acid. Also a spreading of nitric acid into the cleaning baths is avoided.

According to one embodiment of the present invention, in step c) for connecting the individual components a beam welding method is used. Such a beam welding method has relative to welding methods using consumable electrodes the advantage that, during the welding process, residual stresses are introduced only to a small degree into the component which, in particular, during production of the large transmission gear wheels is a great advantage. The beam welding method, for example, may be an electron beam welding method or laser beam welding method, wherein the latter is preferably carried out in a vacuum and/or partial vacuum.

According to a first variant of the method according to the invention, the gaps are sealed by further welding from the rear face, wherein the further welding is preferably also carried out by a beam welding method of the type mentioned above. In other words, each connecting region between two individual components of the gear wheel to be joined is welded twice—once from the front and once from the rear.

According to a second variant of the method according to the invention, before performing the welding in step c) sealing material rings are inserted into the gaps to be sealed, wherein the sealing material rings during the connection of the individual components in step c) are at least fused thereon by the welding heat, whereby the gaps are sealed. Depending on the removal of the gap to be sealed from the welded joint and thus depending on the temperature which is able to be reached during the welding in the gap to be sealed, the sealing material may be soft solder or hard solder. The sealing material should in this case be selected such that the liquidus temperature thereof is not exceeded during the hardening in step d), in order to prevent further fusion of the sealing material. The sealing of the gaps present on the rear face in the region of the welded seams, according to the second variant of the method according to the invention, has the advantage that the connecting welding according to step c) and the sealing of the welded seams produced on the rear face in the region of the welded seams produced in step c) may be carried out at the same time by using one and the same heat source.

According to a third variant of the method according to the invention, before the connecting welding in step c) sealing material rings are inserted into the gaps to be sealed, wherein the sealing material rings during the hardening in step d) are at least fused thereon by the heat supplied to the components in a furnace, whereby the gaps are sealed. In other words, the connecting welding according to step c) and the sealing of the gaps present on the rear face in the region of welded seams produced in step c) are carried out separately from one another, wherein the process heat of the hardening in step d) is used for the sealing. Depending on the temperature of the hardening furnace, a soft solder or a hard solder may be selected as sealing material.

The above-described second and third variants of the method according to the invention are, in particular, used advantageously when the individual components comprise two disk wheels which are arranged axially spaced apart from one another, as the sides of the disk wheels facing one another respectively after the mounting thereof are no longer accessible for further welding on the rear face for sealing said gaps. A further welding on the rear face is accordingly not possible. The provision of two disk wheels, in particular, is advantageous for producing a greater rigidity of the gear wheel.

Preferably the disk wheels are connected together by means of tubular stiffeners, whereby an additional stiffening of the gear wheel is achieved.

Advantageously, both disk wheels relative to the ring gear are mounted from one side and in step b) soft machined from the same side, which may be carried out in one chuck. As a result, the advantage is achieved that the two disk wheels are aligned with one another in their seat in the ring gear. A clamping on both sides with machining on both sides would make this difficult. Accordingly, clamping on both sides of the work piece during production may be advantageously dispensed with, whereby the method sequence is designed to be more simple and more cost-effective. The welding of the two disk wheels according to step c) thus takes place from both sides of the gear wheel.

According to a fourth variant of the present invention, the sealing of the gaps is carried out after the hardening according to step d), wherein for the sealing an organic, metal or inorganic matrix is used as sealing material. In this case, seam sealing materials which are common, for example, in bodywork construction of vehicles or in the field of white goods, such as for example silicone, MS polymers, polyurethane, rubbers, butylene, bitumen, acrylate or even metal ion and organic casting compounds, may be used.

In a preferred embodiment of the present invention, the ring gear is produced from a case hardened steel, wherein the hardening takes place in step d) by means of case hardening. By means of the case hardening, a gear wheel may be provided with the greatest flank strength, so that gear wheels produced by the method according to the invention may also withstand the greatest loads.

Preferably steps a) to f) are performed in the aforementioned sequence. This sequence in the production of a large transmission gear wheel is advantageous, in particular, if the connection in step c) is carried out by using a beam welding method and during the hardening in step d) case hardening is used. Surprisingly it has been shown that only a small degree of component deformation is associated with the combination of a beam welding method and case hardening which may be compensated at low cost during the subsequent hard machining step, without large dimensions having to be allowed therefor. The applicant assumes that the residual stresses which are introduced into the component by the beam welding method are so low that during the case hardening they are completely dissipated. Accordingly, only the component deformation associated with the case hardening remains, which is comparable with the corresponding deformation during production of large transmission gear wheels of one piece configuration and correspondingly controlled. This deformation may also be modified according to the invention by means of the considerably more flexible design of the wheel body construction such that it results in less deformation.

According to one embodiment of the method according to the invention, hard turning and gear teeth grinding take place during the hard machining carried out in step e). In this manner, gear teeth of the highest quality may be produced.

Advantageously, the disk wheel is provided with at least one recess arranged eccentrically, in particular with a plurality of recesses arranged eccentrically. Such recesses generally ensure the removal of vapor and the ability to be flushed through and cleaned, and in the case of case hardening the effective penetration of the carburizing gases and the quenching medium.

Preferably, the disk wheel is of asymmetrical configuration in order to adapt, in particular, the stiffness of a large transmission gear wheel to application-specific loads.

According to one embodiment of the method according to the invention, by the asymmetrical configuration of the thickness of the ring gear, the stiffness of the large transmission gear wheel is adjusted, whereby a uniform load-bearing behavior over a broad load range is able to be achieved. By locally reducing the ring gear thickness in the edge regions, in particular, corner supports may be avoided.

Preferably, according to one embodiment of the method according to the invention, viewed in the welding direction, the rear end of at least one welded joint is formed by a radially protruding projection, which is part of one of the components to the welded together. Such a projection at the end of a welded joint serves as a welding bath support and simplifies the implementation of the welding method.

Advantageously the ring gear comprises a connecting portion with a connecting surface, along which the ring gear is welded to the disk wheel in step c), and a ring gear portion on which the gear teeth are formed, wherein at least one transition radius is provided between the connecting portion and the ring gear portion, said transition radius being arranged at a distance (a) from the welded seam to be produced in step c) connecting the ring gear and the disk wheel together. The distance between the transition radii and the welded seam serves for decoupling the notch effect produced by the welded seam.

Further features and advantages of the present invention will become clear from the following description of exemplary embodiments of the present invention with reference to the accompanying drawings, in which

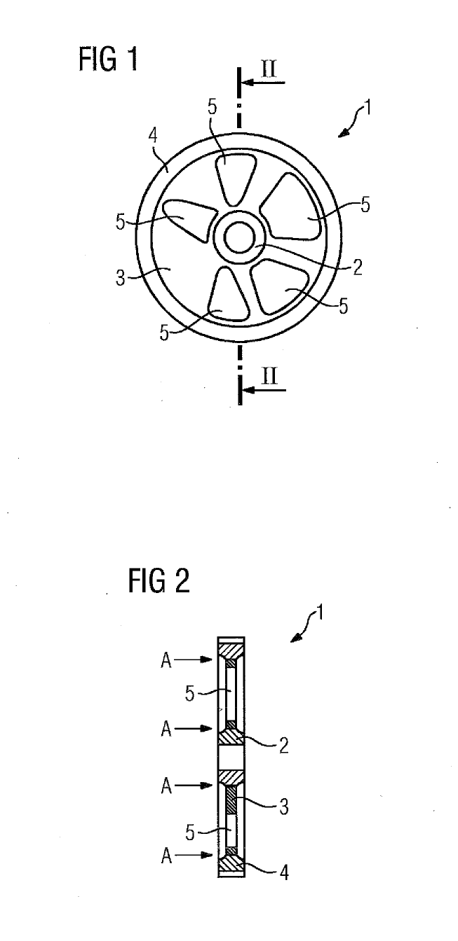

FIG. 1 is a schematic side view of a gear wheel according to a first embodiment of the present invention;

FIG. 2 is a schematic cross sectional view of the gear wheel according to the first embodiment along the line II-II in FIG. 1;

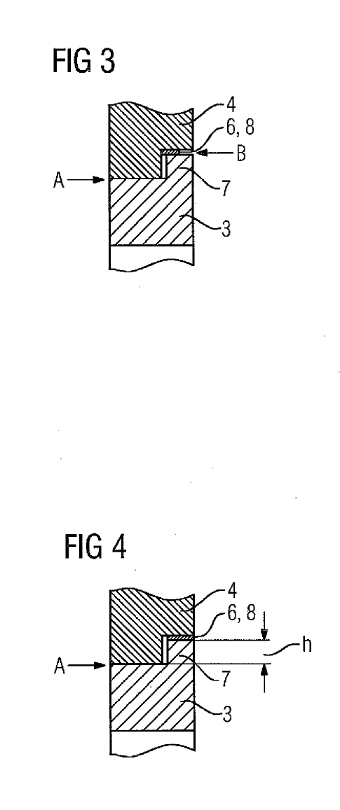

FIG. 3 is a schematic enlarged view of the region identified in FIG. 2 by the reference numeral III, which shows a welded transition between a disk wheel and a ring gear of the gear wheel, wherein a gap present on the rear face in the region of the welded seam according to a first variant of the present invention is sealed;

FIG. 4 is a schematic enlarged view of the region identified in FIG. 2 by the reference numeral III which shows a transition between a disk wheel and a ring gear of the gear wheel, wherein a gap present on the rear face in the region of the welded seam according to alternative variants of the present invention is sealed;

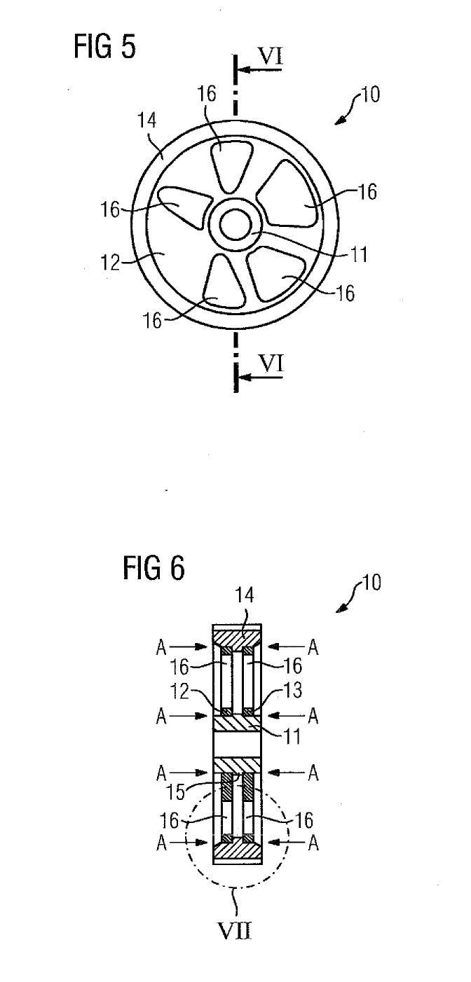

FIG. 5 is a schematic side view of a gear wheel according to a second embodiment of the present invention;

FIG. 6 is a schematic cross sectional view of the gear wheel according to the second embodiment along the line VI-VI in FIG. 5;

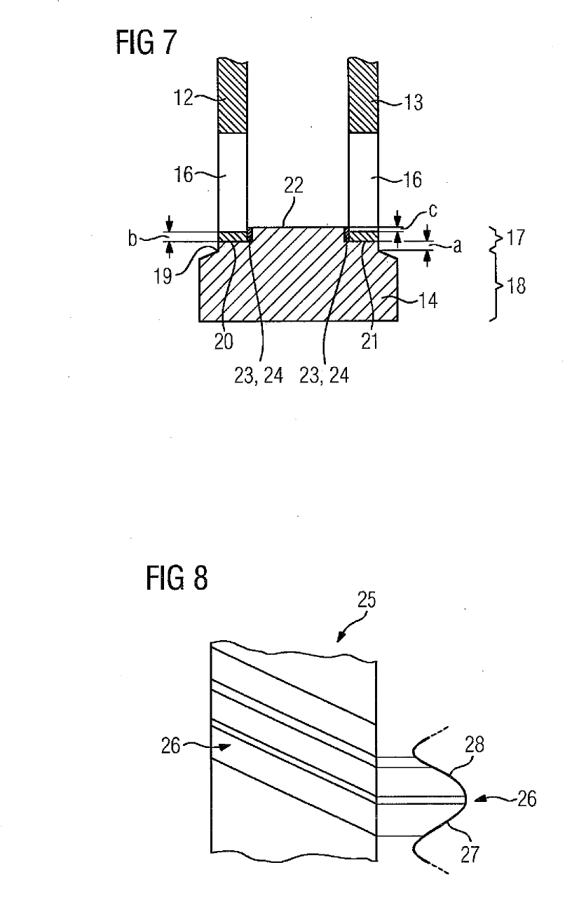

FIG. 7 is a schematic enlarged view of the region identified in FIG. 6 by the reference numeral VII which shows a transition between a disk wheel and a ring gear of the gear wheel;

FIG. 8 is a basic sketch which shows the tooth profile of oblique gear teeth of a ring gear;

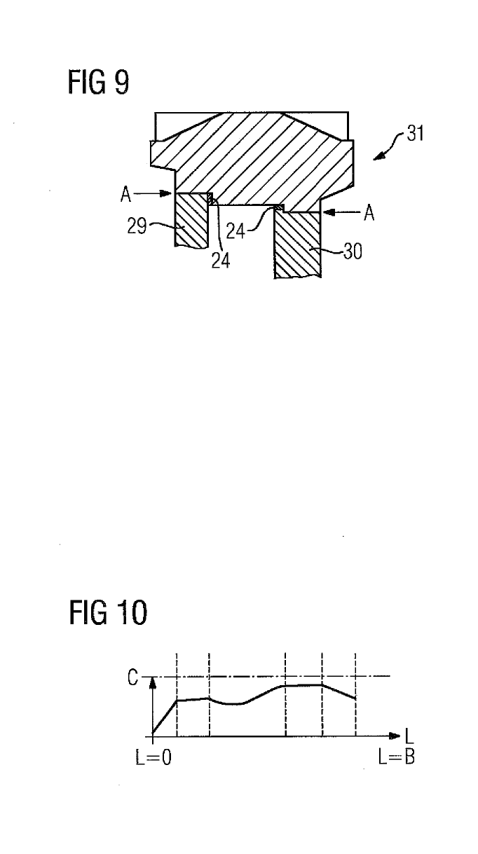

FIG. 9 is a schematically enlarged cross sectional view of a transition between a disk wheel and a ring gear of a gear wheel according to a third embodiment of a gear wheel according to the present invention;

FIG. 10 is a diagram which shows the stiffness curve of the ring gear shown in FIG. 9 over the width of the ring gear;

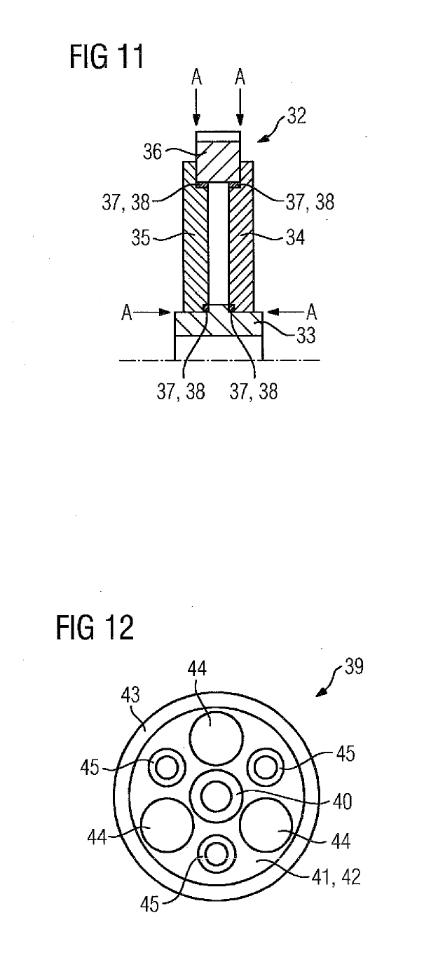

FIG. 11 is a schematic cross sectional view of a gear wheel according to a fourth embodiment of the present invention in which the ring gear and the disk wheel are welded together radially; and

FIG. 12 is a schematic side view of a gear wheel according to a fifth embodiment of the present invention.

FIGS. 1 and 2 show a large transmission gear wheel 1 according to a first embodiment of the present invention which has an external diameter of 600 mm or more. The large transmission gear wheel 1 is a hybrid gear wheel which is produced from a plurality of individual components and namely from a hub which is configured substantially cylindrically 2, a disk wheel 3 and a case-hardened ring gear 4 which are welded together at the positions identified by the arrows A.

The at least one disk wheel 3 is provided with recesses 5 arranged eccentrically. The recesses 5 have in each case different shapes and are distributed asymmetrically on the at least one disk wheel 3 as shown in FIG. 1.

The large transmission gear wheel 1 is produced as follows. The individual components are provided in a first step, i.e. the hub 2, the disk wheel 3 and the ring gear 4. In a further step a mechanical soft machining of the individual components takes place. In this case, the hub 2 is subjected to turning. Subsequently, the ring gear 4 is provided with its gear teeth, which for example may be carried out during the course of a hobbing treatment. Subsequently, the disk wheel 3 is inserted and/or pressed between the hub 2 and the ring gear 4. In this case, light compression of the disk wheel 3 should be used. In a further step the individual components are then connected together at the positions identified by the arrows A by using a beam welding method, wherein preferably the beam welding method is an electron beam welding method. Alternatively, a laser beam welding under vacuum or partial vacuum may also be used.

Subsequently, the large transmission gear wheel 1 is case-hardened in the welded state, whereby the ring gear 4 has a flank strength of 1,250 N/mm², preferably 1,500 N/mm² or more. Then a hard machining follows, during which at least grinding of the ring gear takes place. Additionally, however, also a hard machining of the hub 2 and/or the disk wheel 3 may take place, for example, during a hard turning process.

Subsequent to the hard turning process, a grinding burn test is carried out by using the nital etching method. In order to prevent during the grinding burn test nitric acid from penetrating gaps 6 remaining on the rear face in the region of the welded seams produced, before carrying out the grinding burn test according to the invention a sealing of said gaps 6 takes place. Different sealing variants according to the present invention are described hereinafter with reference to FIGS. 3 and 4, which by way of example show the transition region between the disk wheel 3 and the ring gear 4 in an enlarged view. The subsequent descriptions, however, are also able to be applied to the transition between the hub 2 and the disk wheel 3.

For producing the arrangement shown in FIG. 3 according to a first variant according to the invention the disk wheel 3 and the ring gear 4 are initially positioned correctly relative to one another for the subsequent welding process. In a further step, by using the aforementioned beam welding method, the disk wheel 3 and the ring gear 4 are welded together over the periphery from one side of the gear wheel 1, which is indicated by the arrow A. For achieving an internal welding bath support, the disk wheel 3 at its rear end—viewed in the welding direction (arrow A)—along its outer periphery is provided with a peripheral outwardly protruding projection 7, which engages in a correspondingly configured recess which is configured on the periphery at the rear end of the internal periphery of the ring gear 4. In a further step, the annular gap 6 present on the rear face in the region of the welded seam is closed, by the disk wheel 3 and the ring gear 4 being welded together again from the other side of the gear wheel 1 which is indicated by the arrow B. Also in this case a beam welding method is advantageously used, which preferably is an electron beam welding method or alternatively a laser beam welding method under vacuum or partial vacuum. In this manner, the gap 6 is sealed against the penetration of nitric acid during the subsequent grinding burn test.

For producing the arrangement shown in FIG. 4, according to a second variant according to the invention, initially a sealing material ring 8 which is preferably formed from a hard solder is arranged on the outer periphery of the projection 7 of the disk wheel 3. Alternatively, this may naturally also be correspondingly positioned on the ring gear 4. In a further step for the subsequent welding treatment the disk wheel 3 and the ring gear 4 are positioned correctly relative to one another, whereupon the disk wheel 3 and the ring gear 4 are welded together from one side of the gear wheel 1, as indicated by the arrow A. In the second variant, the height h of the projection 7 and the material of the sealing material ring 8 are selected such that in the region of the sealing material ring 8 by the connecting welding in the direction of the arrow A the temperature is sufficiently high that the sealing material ring 8 is at least fused thereon whereby the gap 6 is sealed. In this case, care has to be taken that the liquidus temperature of the sealing material is sufficiently high that the sealing material is not fused thereon again during the following treatment in the hardening furnace. Advantageously, by its latent heat requirement the fusion process stabilizes the welding depth of the beam welding process, whereby a reduced bath support may be used than is currently usual. This effect corresponds to the object of cost-effective production.

For producing the arrangement shown in FIG. 4, according to a third variant according to the invention, initially the sealing material ring 8 is arranged on the outer periphery of the projection 7 of the disk wheel 3 and/or on the ring gear 4. In a further step similar to the second variant, the disk wheel 3 and the ring gear 4 are positioned correctly relative to one another for the subsequent welding process. Then, by using the aforementioned beam welding method the disk wheel 3 and the ring gear 4 are welded together, which is indicated by the arrow A. In this case, the sealing material ring 8 is spaced sufficiently far apart from the welding point such that it is not fused thereon by the welding heat. Only during the following case hardening is the sealing material ring 8 fused inside the hardening furnace by the temperatures prevailing therein, whereby the gap 6 is sealed. Accordingly, the connection of the disk wheel 3 and the ring gear 4 coincide chronologically with the sealing of the gap 6. Preferably a hard solder is used as the sealing material in this case, the liquidus temperature thereof being in the region of the temperatures prevailing in the case-hardening furnace. In this case and in the previous application, the sealing means advantageously has an additional sealing effect against undesired hardening of the root of the seam by carbon which is highly desirable from the point of view of mechanical fracture.

For producing the arrangement shown in FIG. 4 according to a fourth variant according to the invention, the disk wheel 3 and the ring gear 4 are positioned relative to one another and welded together by means of beam welding. Subsequently the gear wheel 1 is hardened in the hardening furnace and then hard machined. Only after the hard machining is a sealing material ring 8 introduced into the gap 6 and sealed. In this case, the sealing material may be an organic matrix, a metal matrix or an inorganic matrix.

An essential advantage of the described method is that during beam welding of the individual components little heat is introduced into the component which leads to the residual stresses induced by the welding method being relatively low compared to the conventionally used welding methods using consumable electrodes. Accordingly, these residual stresses may be dissipated by the thermal treatment taking place during the case hardening (stress relief tempering). Due to the case hardening, a very high flank strength is provided to the ring gear 4, so that the large transmission gear wheel 1 is able to withstand the greatest loads. The component deformation which is unavoidable during the case hardening is minimized by a corresponding choice of shape and position of the recesses 5. These recesses 5 ensure a correct penetration of carburizing gases during the carburizing process. Moreover, the quenching means are distributed evenly during the quenching process, such that the temperature distribution in the individual regions of the large transmission gear wheel 1 is as uniform as possible during cooling and/or quenching, whereby component deformation is effectively counteracted due to local temperature differences. It should be clear that the recesses 5 may also be differently configured and arranged. For example, a symmetrical arrangement of circular recesses 5 may also be selected if a component having low deformation results thereby.

A further advantage of the method according to the invention is that due to the low component deformation during the previous method steps the hard machining may be carried out at relatively low cost, which is why the costs for the hard machining are relatively low.

A further advantage of the method according to the invention is that by sealing the gaps 6 with sealing material 8 which is resistant to nitric acid during the grinding burn test, a penetration of nitric acid is prevented so that the problems associated with a penetration of nitric acid which have been set forth above may not occur and as a result even the controlled production of this component is permitted.

FIGS. 5 to 7 show a large transmission gear wheel 10 according to a second embodiment of the present invention. The large transmission gear wheel 10 is a hybrid gear wheel which is produced from a plurality of individual components and namely from a hub 11, two disk wheels 12 and 13 and a ring gear 14 which are welded together at the positions identified by the arrows A.

The hub 11 is of substantially cylindrical configuration and comprises a radially protruding projection 15 which extends substantially centrally along the periphery of the hub 11 and serves as a stop for positioning the disk wheels 12 and 13.

The disk wheels 12 and 13 in each case are provided with recesses 16 arranged eccentrically. The recesses 16 in each case have different shapes and are arranged distributed asymmetrically on the disk wheels 12 and 13, as shown in FIG. 5.

The ring gear 14 is produced from a case hardened steel and case hardened. It comprises a connecting portion 17 and a ring gear portion 18 configured in one piece therewith, which are connected together via a transition radius 19. The connecting portion 17 is provided with two annular connecting surfaces 20 and 21, along which the ring gear 14 is welded to the disk wheels 12 and 13. Between the connecting surfaces 20 and 21 extends a projection 22 protruding radially inwardly, which serves as stop for the disk wheels 12 and 13. The dimension a illustrated in FIG. 7 denotes the radial distance between the transition radius 19 and the connecting surfaces 20 and 21 and/or the welded seams provided there. The distance a has to be selected to be sufficiently large that the notch effect, which is produced by the welded seams provided as closed round seams, is safely decoupled. The dimension b illustrated in FIG. 7 denotes the minimum wheel thickness of the disk wheels 12 and 13 for carrying out a thermally acceptable welded seam along the recesses 16 provided on the disk wheels 12 and 13, in order to ensure a substantially uninterrupted and asymmetrical heat dissipation. The dimension c in FIG. 7 is the difference between the radial height of the ring projection 22 of the ring gear 14 and the minimum ring thickness b of the disk wheels 12 and 13 which is required to form a structure for the media used during case-hardening to be able to flow through and drain off, as described below in more detail. The dimensions a, b, and c are selected during the construction based on a corresponding calculation.

The large transmission gear wheel 10 shown in FIGS. 5 to 7, according to one embodiment of a method according to the invention, is produced as follows. In a first step, the individual components are provided, i.e. the hub 11, the two disk wheels 12 and 13 and the ring gear 14. In a further step a mechanical soft machining of the individual components takes place. In this case, the hub 11 is subjected to turning. Then the ring gear 14 is provided with its gear teeth which, for example, may be implemented during a hobbing treatment. Subsequently, the disk wheels 12 and 13 are inserted and/or pressed between the hub 11 and the ring gear 14. To this end, simple interference fits of the disk wheels 12 and 13 should be used. The radii in the projections of the contact surfaces for the disks in the region of radial and axial stop surfaces are to be taken into account according to the internal chamfer of the disk to be inserted. The disks also advantageously have internally a larger radius than on the external side, in which welding takes place. The welding seam should nevertheless be prepared by considering the costs and avoid unnecessary projections. In a further step, the individual components are then connected together at the positions identified by the arrows A using a beam welding method, wherein the beam welding method is preferably an electron beam welding method. Alternatively, a laser beam welding method may also be used under vacuum or partial vacuum.

Subsequently the large transmission gear wheel 10 in the welded state is case hardened, whereby the ring gear 14 obtains a flank strength of 1,250 N/mm², preferably 1,500 N/mm² or more. Then a hard machining follows, during which at least the grinding of the toothed wheel 14 takes place. Moreover, a hard machining of the hub 11 and/or the disk wheels 12 and 13 may follow, for example during a hard turning process.

In a further step the gear wheel 10 is subjected to a grinding burn test by using the nital etching method.

Also in the gear wheel 10 shown in FIGS. 5 to 7, gaps 23 remaining on the rear face in the region of the respective welded seams are sealed by a sealing material 24, in order to prevent the penetration of nitric acid during the welding burn test. For sealing the gaps 23, optionally a sealing method may be selected according to the second or third variant described above with reference to FIG. 4. The first variant is excluded as with the use of two disk wheels 12 and 13 a further welding on the rear face is not possible due to lack of accessibility. The fourth variant also is excluded due to the lack of accessibility.

A substantial advantage of the described method is that during beam welding of the individual components little heat is introduced into the component which has the result that the residual stresses induced by the welding method are relatively low in comparison with the conventionally used welding method using consumable electrodes. Accordingly, said residual stresses may be dissipated by the thermal treatment taking place during case hardening (stress relief tempering). By a corresponding choice of dimensions a, i.e. the distance of the transition radii 19 to the welded seams and/or connecting surfaces 20 and 21, the notch effect is also decoupled. Due to the case hardening the ring gear 14 is provided with very high flank strength, so that the large transmission gear wheel 10 is able to withstand the greatest loads. The component deformation which is not to be avoided during the case hardening is minimized by a corresponding choice of shape and position of the recesses 16. These recesses 16 ensure a correct penetration of carburizing gases during the carburizing. Moreover, the quenching means during the quenching process are uniformly distributed such that the temperature distribution in the individual regions of the large transmission gear wheel 10 during cooling and/or quenching is as uniform as possible, whereby component deformation due to local temperature differences is effectively counteracted. Moreover, the cleaning of the large transmission gear wheel 10 is also improved by means of the recesses 16. It should be clear that the recesses 16 may also be configured and arranged differently. For example, a symmetrical arrangement of circular recesses 16 may also be selected if this results in a component having low deformation.

A further advantage of the method according to the invention is that due to the low component deformation during the above method steps the hard machining may be carried out at relatively low cost which is why the costs for the hard machining are relatively low.

A further advantage of the method according to the invention is that by the sealing of the gaps 23 with sealing material 24 which is resistant to nitric acid, a penetration of nitric acid is prevented during the grinding burn test so that the problems associated with the penetration of nitric acid which have already been set forth above may not occur.

FIG. 8 shows schematically the tooth profile 25 of oblique gear teeth of a ring gear 14 in plan view and in side view. The driving gear wheel 26 during operation engages with the more acute-angled tooth edge 27 into the driven wheel (not shown). This tooth edge 27 is in principle less rigid that the opposing tooth edge 28 having an obtuse angle. The contact pattern of the oblique gear teeth moves with increasing load from the tooth edge 27 to the tooth edge 28 and is optimized according to a specific topographical correction in the contact pattern.

The load-bearing behavior of gear wheels, in particular in the case of high strength, case-hardened gear wheel materials which permit a high load-bearing capacity, is superimposed by a noticeable deformation of the resilient transmission parts and components. Also the flexion at the tooth tips generally is many times greater than the shape deviations on the tooth as a result of the production process. The overload also causes deflections and twisting of the pinion shaft and gear wheel shaft, pinion body and disk wheel body and lowering of the bearings and housing deformations. This results in misalignments of the tooth flanks which are frequently considerably greater than the flank line deviations as a result of the production process. This results in a non-uniform bearing of the gear teeth surface in height and width, which negatively influences both the load-bearing capacity and the noise behavior.

In order to reproduce the high load-bearing capacity of high strength gear wheels and to reduce greater noise development, specific deviations from the involute (height modification) and from the theoretical flank line (width modification) are carried out in order to obtain almost ideal geometries with uniform load distribution under load. When determining the height and width modifications, the overall area of influence of the substructure has to be taken into account. The deformation chain via the gear wheel, the shaft, the bearing assembly, the housing and the housing connection to the main shaft has to be considered. By modifying the height at the tooth tip or even at the tooth root and by modifying the flank or width, the involute is superimposed by a corrected shape, which is intended to permit a uniform bearing of the teeth and the dissipation of the load concentration at the tooth ends during axial displacements. These effects are calculated on the individual components and then added together and transmitted as an interface to the subsequent gear teeth layout and also have to take into account the respective joints of the welded large transmission gear wheels. In particular, the shaft deformation, the bearing deformation, the production tolerances which have to be considered, the deformation of the gear teeth and the deformation of the joined disk wheels have to be allowed for. Thus a further problem is to consider specifically the deformation of the welded large transmission gear wheel with gear wheels subjected to high load.

FIGS. 9 and 10 show a variation in the stiffness which is able to be produced according to the invention. By increasing the thickness of the ring gear on one side, according to the invention the stiffness is able to be manipulated for supporting the ring gear. This may be matched to the driving wheel and the driven wheel, so that a corrected shape of the gear teeth is superimposed for a more uniform load-bearing behavior over a broad load range. FIG. 9 shows a ring gear 31 welded to disk wheels 29 and 30, which is the ring gear 26 of the driving wheel in a modified state shown in FIG. 8. An advantage of this modification according to the invention is that the edge regions of the gear teeth of the ring gear 31, due to locally reduced ring gear thicknesses, are supported in a less rigid manner in order to avoid corner supports, i.e. excessive and damaging support only via the edges. Moreover, the interfaces between the disk wheels 29 and 30 and the ring gear 31 are easily accessible by reducing the thickness of the ring gear on the radial internal edge regions of the ring gear 31, whereby a positive weld beam coupling is permitted in the direction of the arrows A. A further positive effect is that the turning machining of the ring gear 31 is possible on one side during the soft machining process, whereby costly clamping on both sides of the component is avoided.

FIG. 11 is a schematic view of a hybrid large transmission gear wheel 32 according to a further embodiment of the present invention, which also is produced from a hub 33, two disk wheels 34 and 35 and a ring gear 36. While the hub together with the disk wheels 34 and 35, as in the previous embodiments, are welded together in the axial direction, the disk wheels 34 and 35 are welded to the ring gear 36 in this embodiment in the radial direction. The sealing of the gaps 37 with sealing material 38 also takes place in this case either according to the above-described second variant or the third variant.

FIG. 12 shows a schematic side view of a large transmission gear wheel 39 according to a further embodiment of the present invention. The large transmission gear wheel 39 is also a hybrid gear wheel with a hub 40, two disk wheels 41 and 42 and a ring gear 43 which are welded together. The construction of the large transmission gear wheel 39 substantially corresponds to that of the large transmission gear wheel 10 shown in FIGS. 5 to 7. In contrast to the large transmission gear wheel 10 the recesses 44, however, are symmetrically arranged in the gear wheel 39 and have a circular shape. Moreover, axially extending tubular stiffeners 45 which connect together the disk wheels 41 and 42 are provided, whereby the construction is additionally reinforced. Moreover, the structures of the large transmission gear wheels 10 and 39 correspond to one another.

Although the invention in detail has been illustrated and described more clearly by the preferred exemplary embodiments, the invention is not limited by the disclosed examples and other variants may be derived therefrom by the person skilled in the art without departing from the protected scope of the invention which is defined by the accompanying claims.

Although the invention in detail has been illustrated and described more clearly by the preferred exemplary embodiment, the invention is not limited by the disclosed examples and other variants may be derived therefrom by the person skilled in the art without departing from the protected scope of the invention.

1.-19. (canceled)

20. A method for producing a spur-cut gear wheel, comprising:
subjecting individual components of the spur-cut gear wheel to at least partial mechanical soft machining;
joining the individual components by welding seams using a welding process;
hardening at least one of the individual components;
hard machining the at least one of the individual components;
sealing a gap on a rear face in a region of the welded seams by a sealing material which is resistant to nitric acid; and subsequently
performing a grinding burn test by using a nital etching process.

21. The method of claim 20, wherein the individual components are selected from the group essentially consisting of hub, disk wheel, and ring gear.

22. The method of claim 20, wherein the welding process involves a beam welding method.

23. The method of claim 20, further comprising sealing the gap by further welding from the rear face.

24. The method of claim 23, wherein the further welding involves a beam welding method.

25. The method of claim 20, further comprising, before the individual components are joined by the welding seams, inserting sealing material rings into the gap to be sealed, and at least fusing the sealing material rings upon the individual components by welding heat as the individual components are joined by the welding seams, thereby sealing the gap.

26. The method of claim 20, further comprising, before the individual components are joined by the welding seams, inserting sealing material rings into the gap to be sealed, and at least fusing the sealing material rings upon the at least one component during hardening of the at least one component by heat supplied in a furnace.

27. The method of claim 20, wherein the individual components comprise two disk wheels arranged in axially spaced-apart relationship to one another.

28. The method of claim 27, further comprising connecting the disk wheels together by tubular stiffeners.

29. The method of claim 27, wherein the one of the individual components is a ring gear, and further comprising mounting the disk wheels in relation to the ring gear from one side, with the disk wheels being subjected to the soft machining from said side.

30. The method of claim 20, wherein the gap is sealed after the at least one individual component undergoes hardening, with the sealing material being selected from the group consisting of an organic, metal, and inorganic matrix.

31. The method of claim 20, wherein the one of the individual components is a ring gear produced from a case hardened steel and hardened by case hardening.

32. The method of claim 20, wherein the steps of subjecting the individual components of the spur-cut gear wheel to at least partial mechanical soft machining, joining the individual components by the welding seams using the welding process, hardening the at least one of the individual components, hard machining the at least one of the individual components, and sealing the gap on the rear face in the region of the welded seams by a sealing material which is resistant to nitric acid, are executed in this sequence.

33. The method of claim 20, wherein the gear wheel is a transmission gear wheel.

34. The method of claim 20, wherein the one of the individual components is a ring gear, said ring gear being hard-machined by hard turning and grinding of gear teeth of the ring gear.

35. The method of claim 20, wherein one of the individual components is a disk wheel, and further comprising providing the disk wheel with at least one recess arranged at least eccentrically.

36. The method of claim 35, wherein the disk wheel has an asymmetrical configuration.

37. The method of claim 20, wherein one of the individual components is a ring gear having a thickness which is asymmetrical to thereby adjust a stiffness of the gear wheel.

38. The method of claim 20, further comprising forming, when viewed in a welding direction, a rear end of one of the individual components with a radially protruding projection for joining with another one of the individual components at at least one joint.

39. The method of claim 20, wherein the at least one of the individual components is a ring gear which comprises a connecting portion with a connecting surface, along which the ring gear is joined by welding to another one of the individual components in the form of a the disk wheel, and a ring gear portion on which gear teeth are formed, wherein at least one transition radius is provided between the connecting portion and the ring gear portion and arranged at a distance from the welded seams that join the ring gear and the disk wheel together.
